(19) United States
(12) Patent Application Publication
(10) Pub. No.: US 2006/0201037 A1
(43) Pub. Date: Sep. 14, 2006

(54) Transparent bag with sewn-on fasteners

(76) Inventor: Dan Blau, Winnetka, IL (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/406,672

(22) Filed: Apr. 19, 2006

Related U.S. Application Data
(63) Continuation of application No. 10/990,261, filed on Nov. 16, 2004.
Application No. 10/990,261 is a continuation of application No. 10/252,624, filed on Sep. 23, 2002, now Pat. No. 6,890,101.
Application No. 10/252,624 is a continuation-in-part of application No. 09/902,115, filed on Jul. 10, 2001, now abandoned.

(51) Int. Cl. G09F 1/00

(52) U.S. Cl. 40/124.06

(57) ABSTRACT

A display bag for children's products has deformable panels with edges that form an opening that enables objects to be inserted into the bag. A display card adjacent to the back panel extends substantially the entire length and width of a transparent section of the back panel. A flap that is connected to the back panel, near the edge that defines part of the opening, extends across part of the width of the back panel and into the bag, covering a portion of the display card and helping to hold the display card in position.

### RELATED APPLICATIONS

This application is a continuation of co-pending U.S. application Ser. No. 10/990,261, filed Nov. 16, 2004, which was a continuation of U.S. application Ser. No. 10/252,624, filed Sep. 23, 2002 (now U.S. Pat. No. 6,890,101, issued May 10, 2005), which was a continuation-in-part of U.S. application Ser. No. 09/902,115, filed Jul. 10, 2001 and now abandoned.

### BACKGROUND OF THE INVENTION

The present invention relates generally to a transparent container or bag. The bag can be used as both as a container for merchandise while in the hands of a retail merchant, and as a vehicle for repackaging and storing the merchandise while in the possession of the retail purchaser. Bags of this type are manufactured of non-rigid plastic sheets which can be easily folded. It is desirable to have at least front and back walls of the container be transparent which makes it easy to see the bag contents. Although the transparent bag can be used for many purposes, the bag is especially useful for displaying and storing cloth books.

The bag has at least one transparent panel which is adapted to hold a display card. This card has substantially the same general width and length as the bag's front or back walls, and typically contains information concerning the contents of the bag, the identity of the manufacturer or distributor, and other information of potential interest to a consumer. Such cards are typically manufactured from light cardboard or stiff paper, but other materials (e.g., plastic) could also be used. In addition to providing information on the contents, the card, once inserted, also functions as a stiffener, adding additional rigidity to the package.

Another desirable feature of a container of this type is ease of opening and closing. Because the bag is designed to be opened and closed on multiple occasions by the purchaser, the closure system should be both simple to use and sturdy. A hook and loop fastening system (commonly marketed under the trademark Velcro®) is ideal for this purpose. Fastening systems incorporating a first Velcro® member on a closure flap and a second closure Velcro® member on a front panel have been previously used. These Velcro®(& patches have been adhered to the surface of the bag by glue or the like.

### SUMMARY OF THE INVENTION

Although transparent bags having display cards are known in the art, one problem has been a system for placing the display cards in the package. Transparent bags of this type should be generic enough so that they can be used for a variety of products, with the display card serving as a major means for differentiating the bags' contents. Thus, on the one hand, the process of inserting the card into the bag should not be labor intensive. On the other hand, the display card should be placed firmly enough in the transparent bag so that the mere act of removing the bag's contents does not result in removal of the card at the same time. Stated another way, the frictional engagement between the card and bag can cause the card to be displaced when the contents are removed. One aspect of the present invention is a solution to this problem.

As noted above, glued-on Velcro® patches have been used as means to open and close such transparent containers. One problem with glued-on patches is that over time the periphery of the Velcro® patches de-laminates from the surface. While the art has attempted to deal with this problem by using stitched-on patches, the sewing methods employed leave an edge portion which can work itself away from the closure flap or the wall of the bag. To the extent that these containers are used to package items for small children, the presence of something which can pose a risk of choking is another problem. Another aspect of the present invention provides a solution to this second problem.

With respect to the problem of mounting and maintaining a display card in the transparent container, the present invention utilizes a retaining strip along the top of one wall or panel of the transparent bag. In the illustrated embodiment, the top edge and one side of the strip are secured to the bag; the bottom strip edge and the other side are open, allowing easy insertion of a display card during the packaging operation. The issue of a permanently-mounted fastening system is addressed by attaching Velcro®patches by means of continuous zig-zag stitching around the entire periphery of the patches. This method of attachment has been found to withstand repeated closing and unclosing without presenting an area of de-lamination where a small child could attack with fingers or teeth.

### BRIEF DESCRIPTION OF THE FIGURES

Other aspects of the present invention will be more clearly understood from an examination of the appended drawings and detailed description, wherein:

FIG. 1 is a perspective view of a transparent bag of the present invention with the display-card-containing region facing forward; and

FIG. 2 is a perspective view, partially in section, with the display-card-containing region facing toward the rear.

### DETAILED DESCRIPTION OF THE PREFERRED EMBODIMENT

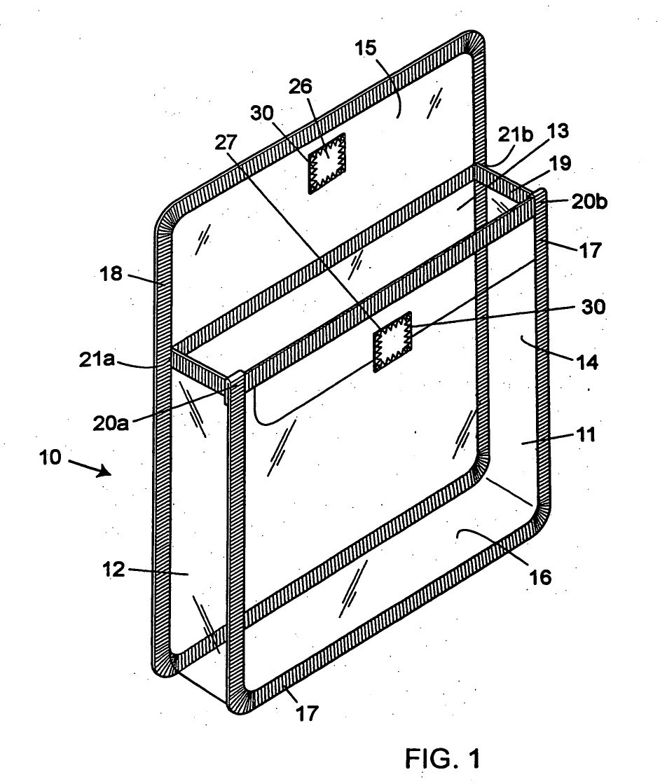

FIGS. 1 & 2 show a transparent container or bag 10 which is adapted to hold a child's cloth book. Bag 10 has front and back panels 11, 13, side panels 12, 14, a bottom panel 16, and a top, closure flap 15, all of which are manufactured of a clear plastic material. Closure flap 15 is a continuation of (integral with) back panel 13.

As shown in FIG. 1, side panels 12, 14 and bottom panel 16 are formed from a single continuous transparent strip. If desired, these panels can be fabricated from three or two pieces, rather than from a single strip. Moreover, side panels 12, 14 and bottom panel 16 can be formed from a non-transparent material.

The various panels of bag 10 are attached to gusset members 17, 18 and 19 which function both to attach the various plastic panels to one another and to provide rigidity to the bag structure. Thus, rectangular top gusset member 19 interconnects front panel 11, side panels 12 and 14, and rear panel 13, and provides a rectangular opening for insertion of an object, such as a cloth book. A U-shaped front gusset member 17 is mounted around three sides of front panel 11. Front gusset member is attached to top gusset member 19 at 20a, 20b. Rear gusset member 18 extends around rear panel 13 and its integral closure flap 15. Rear gusset member 18 is attached to top gusset member 19 at 21a, 21b.

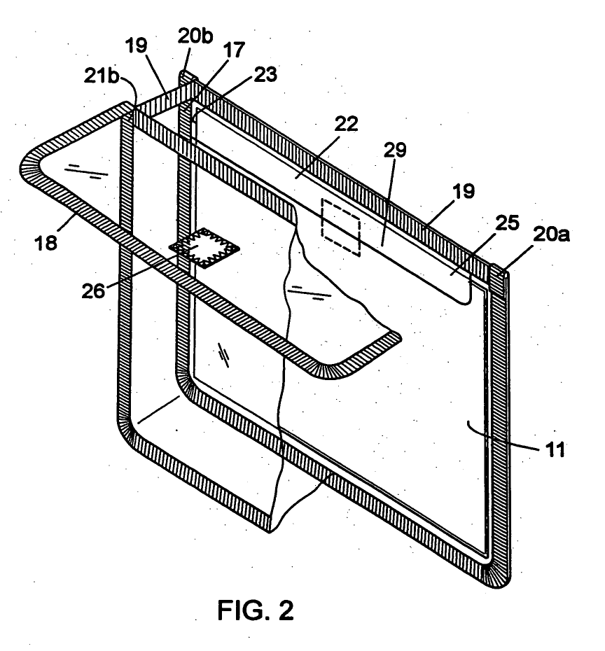

Referring now to FIG. 2, bag 10 has a retaining strip 22 which is mounted inside the bag structure, behind front panel 11. As shown in FIG. 2, retaining strip 22 is manufactured of a clear plastic material having the same characteristics as front panel 11. Indeed, strip 22 can be fashioned by simply bending the top end of panel 11 backwards.

Retaining strip 22 is secured along its top edge by rectangular (top) gusset member 19. A first side end 23 of strip 22 is secured to front gusset 17 slightly below region 20b-where gussets 19 and 17 intersect. The opposite or free end 25 of retaining strip 22 is unattached, as is strip bottom edge portion 29, allowing insertion of a rectangular display card (not shown) having approximately the same dimensions as front panel 11 between retaining strip 22 and the back side of front panel 11. This construction allows easy insertion of a display card, but will prevent the card from being dislodged from the bag when items are inserted and (in particular) removed.

In the embodiment illustrated in FIGS. 1 and 2, retaining strip 22 is shown as being mounted behind front panel 11. It is, of course, equally possible to mount retaining strip 22 behind rear panel 13 in the same manner. Indeed, in instances where it is desirable, two retaining strips can be employed, thus allowing the use of two display cards.

A Velcro® hoop fastener patch 26 is mounted to closure flap 15 and a Velcro® loop fastener patch 27 is mounted to front panel 11, permitting bag 10 to be closed. Patches 26, 27 are attached by a sewing operation which employs zig-zag stitching around the entire periphery of the patches to attach them to the surface of bag 10. Zig-zag stitches 30 provide a more secure attachment of patches 26, 26 to flap 15 and panel 11. The nature of the patches attached to each panel can be reversed. That is, a hoop fastener patch 26 can be mounted on front panel 11 and a loop fastener patch 27 on closure flap 15. However, if a hoop-type fastener is employed as the first closure member, a loop-type fastener member must be employed as the second closure member.

1. A display bag that has:
a deformable front panel that has a transparent section;
a deformable back panel that has a transparent section, a substantial width, and a substantial depth;
panels that connect the front panel to the back panel;
an opening that is defined by edges of the front panel, the back panel, and at least two of the other panels and enables objects to be inserted into the bag;
a display card that is adjacent to the back panel and extends substantially the entire length and width of the transparent section of the back panel; and
a flap that:
is connected to the back panel, near the edge that defines part of the opening;
extends across part of the width of the back panel;
extends from the back panel into the bag, covering a portion of the display card; and
helps to hold the display card in position.

2. A display bag for children's products as recited claim 1.

3. A display bag as recited in claim 1, in which the entire front panel is transparent.

4. A display bag as recited in claim 1 in which the entire back panel is transparent.

5. A display bag as recited in claim 1, in which the panels and the flap are transparent.

6. A display bag as recited in claim 1, in which the display card extends substantially the entire length and width of the back panel.

7. A display bag as recited in claim 1, in which the flap is made of the same material as the back panel.

8. A display bag for children's products as recited claim 1, in which the entire front panel is transparent.

9. A display bag for children's products as recited in claim 1, in which the entire back panel is transparent and the flap is made of the same material as the back panel.

10. A display bag for children's products as recited in claim 1, in which the display card extends substantially the entire length and width of the back panel.

11. A display bag for children's products as recited in claim 1, in which the entire back panel is transparent, the flap is made of the same material as the back panel, and the display card extends substantially the entire length and width of the back panel.

12. A display bag for children's products as recited in claim 1, in which front panel, the back panel, and the flap are made of the same material, and the display card extends substantially the entire length and width of the back panel.

13. A display bag for children's products as recited in claim 1, in which the bag further comprises:
two co-operating hook-and-loop closure members; and
zig-zag stitching that passes over the outside edge of one of the hook-and-loop closure members, holding the closure member to the bag and leaving no exposed edge that a child could use to pull the closure member from the bag.
